(19) United States
(12) Patent Application Publication
(10) Pub. No.: US 2023/0038258 A1
(43) Pub. Date: Feb. 9, 2023

(54) SYSTEMS AND METHODS FOR ANALYSIS OF USER BEHAVIOR TO IMPROVE SECURITY AWARENESS

(71) Applicant: KnowBe4, Inc., Clearwater, FL (US)

(72) Inventor: Mark William Patton, Clearwater, FL (US)

(73) Assignee: KnowBe4, Inc., Clearwater, FL (US)

(21) Appl. No.: 17/876,274

(22) Filed: Jul. 28, 2022

Related U.S. Application Data
(60) Provisional application No. 63/227,167, filed on Jul. 29, 2021.

(51) Int. Cl. G06F 21/57; G09B 19/00; G06F 21/55

(52) U.S. Cl. CPC G06F 21/577; G09B 19/0053; G06F 21/552

(57) ABSTRACT

Systems and methods are disclosed for analysis of user behavior data to improve security awareness. User behavior data of an organization is received from one or more agents on endpoint devices accessed by the users and using the user behavior data, one or more risk scores representative of the severity of risk associated with the user behavior of the users are determined. Based on the one or more risk scores representative of the severity of risk associated with the user behavior of the users, the behavior of the is determined to pose a security risk to the organization, In response to the determination that the user behavior of the users of the organization poses a security risk to the organization, electronic security awareness training is delivered to the users.

### RELATED APPLICATIONS

This patent application claims the benefit of and priority to U.S. Provisional Patent Application No. 63/227,167 titled “SYSTEMS AND METHODS FOR ANALYSIS OF USER BEHAVIOR TO IMPROVE SECURITY AWARENESS,” and filed Jul. 29, 2021, the contents of all of which are hereby incorporated herein by reference in its entirety for all purposes

This disclosure generally relates to security awareness training. In particular, the present disclosure relates to systems and methods for analysis of user behavior data to deliver electronic training to users to improve security awareness.

### BACKGROUND OF THE DISCLOSURE

Organizations have recognized that cybersecurity incidents are a prominent threat that can cause serious breaches of data including confidential information. The cybersecurity incidents can cost the organizations millions of dollars each year in actual costs and can cause customers to lose trust in the organizations. The number of incidents of cybersecurity attacks and the costs of mitigating the damage is increasing increase every year. Many organizations invest in cybersecurity tools such as antivirus, anti-ransomware, anti-phishing, and other quarantine platforms. Such cybersecurity tools may detect and intercept known cybersecurity attacks. However, new and unknown security threats may not be readily detectable by such cyber security tools, and the organizations may have to rely on their employees (referred to as users) to recognize such threats. To enable their users to stop or reduce the rate of cybersecurity incidents, the organizations may conduct programs of security awareness training for their users. The organizations may operate such programs through an in-house cybersecurity team or may use third-parties which are experts in matters of cybersecurity. Through security awareness training, the organizations educate their users on how to detect and report suspected phishing messages, avoid clicking on malicious links and use applications and websites safely. The security awareness training recognizes that when technology such as firewalls and security appliances are insufficient to keep the organization secure, it is the people within the organization that are the last line of defense in protecting corporate information, data, intellectual property, and other assets.

### BRIEF SUMMARY OF THE DISCLOSURE

At times, user behavior at an endpoint may create risks for an organization's cybersecurity. For example, users may put the organization at risk by visiting insecure or malicious websites or by using an application in a way that is not secure. The organizations may often provide training to all users over general website usage or general training concerning all applications, regardless of the user's role or the websites and applications they should be using. Such generalized training may result in the users undergoing training that is not relevant to them, and the training may not provide enough of the cybersecurity skills required to keep the organization safe. Also, cybersecurity attacks involving business-related websites and applications are becoming more prevalent, and usage of such websites and applications can lead to serious security incidents. The organizations may block websites or applications they do not want users to have access to. At times, the blocked websites and/or applications may be relevant to some users and can prevent them from having access to content they actually need.

Risks may arise in the case of a user using websites and applications that are generally considered “safe” and not knowing how to best use them safely. For example, a user may use an application to make video calls but may not consider that the video call is being recorded and transcribed, creating a permanent electronic record of their statements. In another example, a user may not appreciate having confidential information on a whiteboard that other participants in the video call being able to read. In many instances, a user's job role may dictate whether it is appropriate or in compliance with an organization's policy for a user to be visiting a certain website or using a certain application.

A user who does not adhere to an organization's policies around application and website use may be harmful to that organization. This is because the website the user is trying to visit or the application the user is trying to use may not be appropriate to the user's role. For example, an organization may have a policy to prevent a user on a research and development team from visiting websites that contain third-party patents, while someone from a legal department of the organization may be authorized by organizational policy to access that same web site.

The present disclosure generally relates to systems and methods for analysis of user behavior to improve security awareness. In an example embodiment, a method is provided for delivering security awareness training to one or more users of an organization following detection of the one or more users poses a security risk to the organization. The method comprises; receiving, user behavior data of one or more users of an organization from one or more agents on one or more endpoint devices accessed by the one or more users; determining, using the user behavior data, one or more risk scores representative of the severity of risk associated with the user behavior of the one or more users; determining, based on the one or more risk scores representative of the severity of risk associated with the user behavior of the one or more users, that the behavior of the one or more users poses a security risk to the organization; and delivering, in response to the determination that the user behavior of the one or more users of the organization poses a security risk to the organization, electronic security awareness training to the one or more users.

In some implementations determining the one or more risk scores representative of the severity of risk associated with the user behavior of the one or more users includes categorizing, using the user behavior data, one or more applications or websites accessed by the one or more users into one or more categories; and determining, the one or more risk scores of the one or more users based at least on the one or more categories of the one or more applications or websites accessed by the one or more users.

In some implementations the user behavior data comprises one or more of any of the following: websites the one or more users have visited and any associated metadata, applications on the one or more endpoint devices and any associated metadata, applications initiated or running on the one or more endpoint devices and any associated metadata, configuration of a browser the one or more endpoint devices and any associated metadata, credentials stored in the browser and any associated metadata and any file downloaded from the browser onto the one or more endpoint devices and any associated metadata.

In some implementations the method categorizes one or more applications or websites accessed by the one or more users into one or more categories comprising identification of a core function.

In some implementations the core function comprises one of a word processor, video conferencing, financial accounting, or sales planning.

In some implementations the method categorizes the one or more applications or websites accessed by the one or more users into one or more categories comprising identification of an attribute.

In some implementations the attribute comprises one of the following: whether there are fields to input credentials on the website, whether the website or application uses camera or microphone access, whether the website was visited securely or not, whether the website is associated with stored credentials in the browser, a length of time credentials have been stored in a browser, a file type downloaded from the browser, a frequency of use of the website or the application by the one or more users.

In some implementations the method includes determining the risk score for the one or more users based at least on a job role of the one or more users.

In some implementations the method determines a type of electronic security training to provide to the one or more users based at least on the one or more categories and the risk score of the one or more users.

In some implementations the method the type of electronic security training is provided to the endpoint device of the one or more users.

In a further example embodiment, a method for determining a risk score of a user based on user behavior data includes receiving, user behavior data of a user from one or more agents on one or more endpoint devices accessed by a user; categorizing, using the user behavior data, one or more applications or websites accessed by the user into one or more categories; determining, a risk score of the user based at least on the one or more categories of the one or more applications or websites accessed by the user, and; providing, for display, the risk score of the user.

In some implementations, the user behavior data includes one or more of any websites the user has visited and any associated metadata, applications on the one or more endpoint devices and any associated metadata, applications initiated or running on the one or more endpoint devices and any associated metadata, configuration of a browser the one or more endpoint devices and any associated metadata, credentials stored in the browser and any associated metadata, and any file downloaded from the browser onto the one or more endpoint devices and any associated metadata.

In some implementations, the method further includes categorizing one or more applications or websites accessed by the user into one or more categories including identification of a core function.

In some implementations, the core function includes one of a word processor, video conferencing, financial accounting, or sales planning.

In some implementations, the method further includes categorizing one or more applications or websites accessed by the user into one or more categories including identification of an attribute.

In some implementations, the attribute includes one of: whether there are fields to input credentials on the website, whether the website or application uses camera or microphone access, whether the website was visited securely or not, whether the website is associated with stored credentials in the browser, a length of time credentials have been stored in a browser, a file type downloaded from the browser, or a frequency of use of the website or the application by the user.

In some implementations, the method further includes determining, a risk score for the user based on the user behavior data.

In some implementations, the method further includes determining, the risk score for the user based at least on a job role of the user.

In some implementations, the method further includes determining, a type of electronic security training to provide to the user based at least on the one or more categories and the risk score of the user.

In some implementations, the method further includes providing, a type of electronic security training to the endpoint device of the user.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 depicts an implementation of some of the server architecture of a system configured for analysis of user behavior to improve security awareness, according to one embodiment;

FIG. 3 illustrates a process of determining a risk score of a user based on user behavior data, according to one embodiment; and

FIG. 4 illustrates a process of providing a type of electronic security training to the user based at least on the risk score of the user, according to one embodiment.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods that are useful for analysis of user behavior, and providing training based on the user behavior to improve security awareness.

### A. Computing and Network Environment

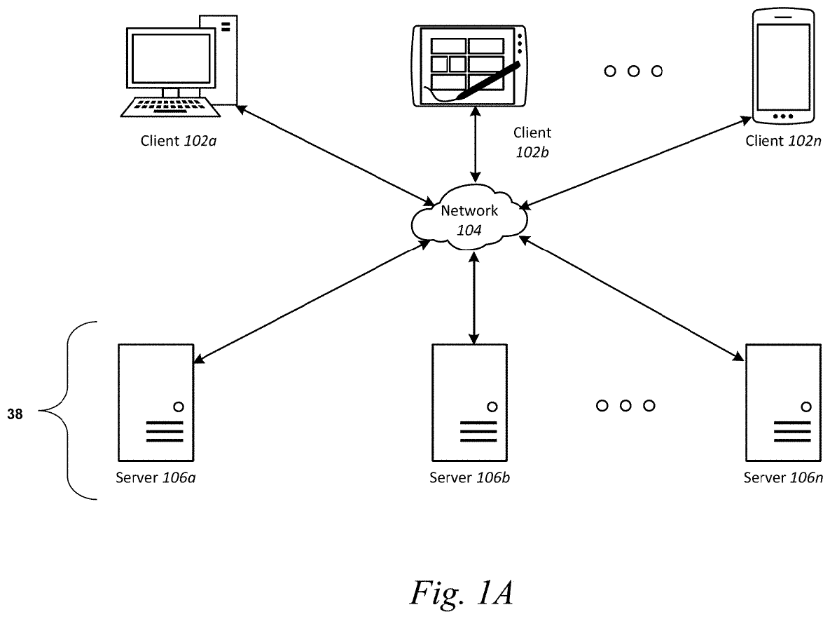

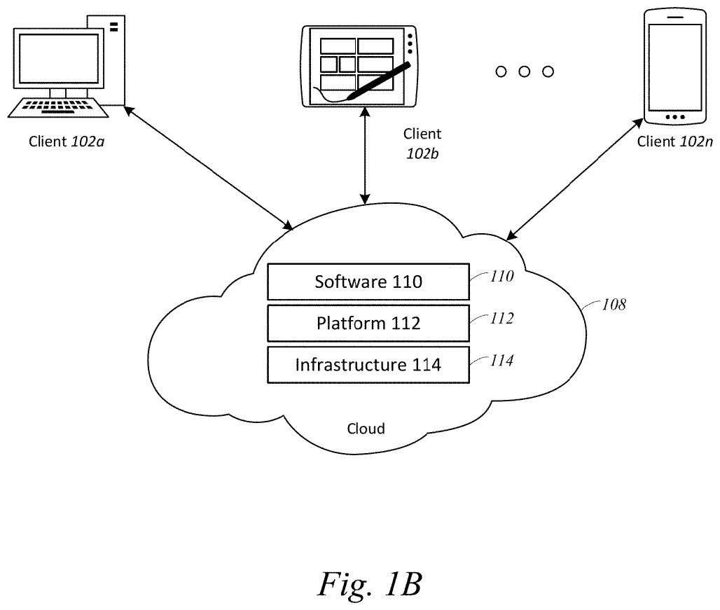

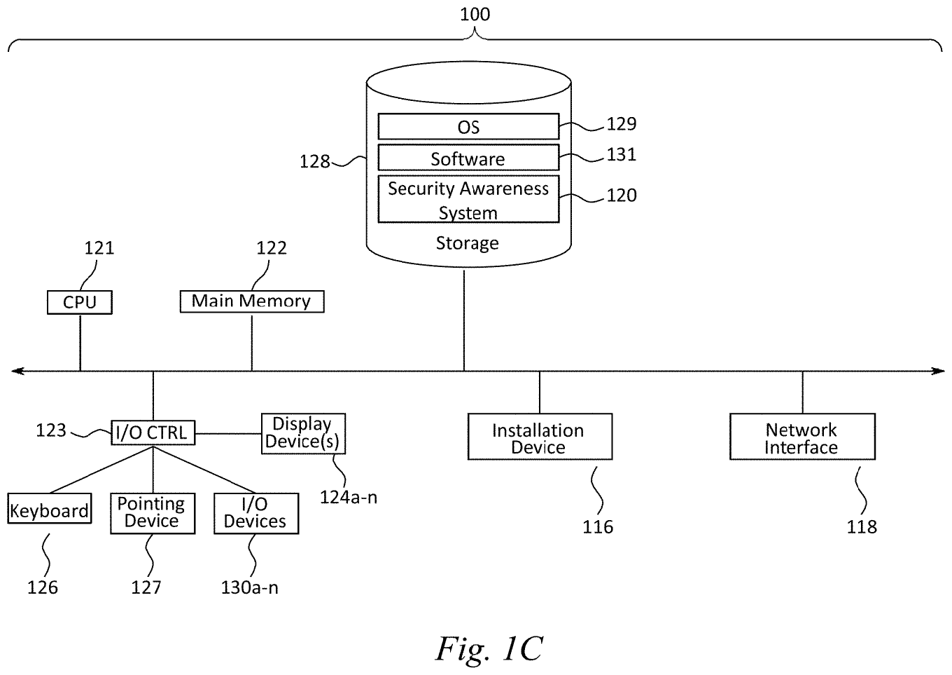

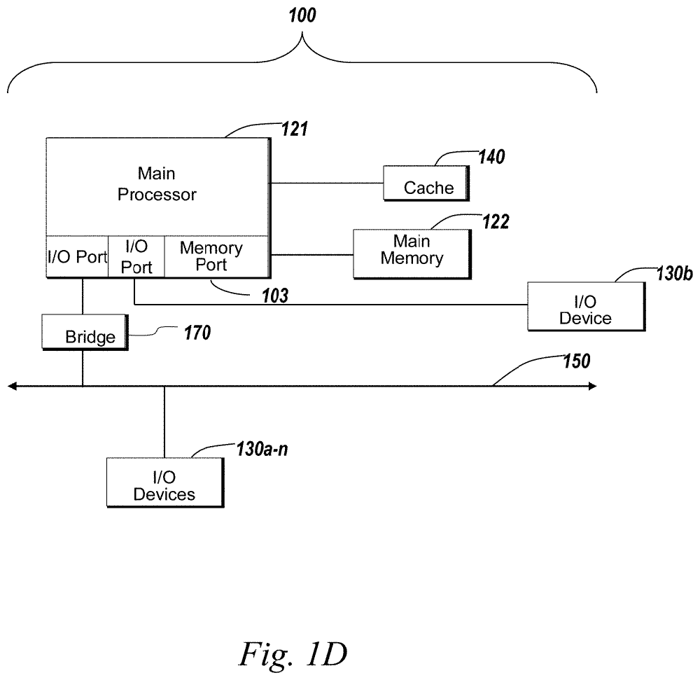

Prior to discussing specific embodiments of the present solution, it may be helpful to describe aspects of the operating environment as well as associated system components (e.g. hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel, or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. The network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Wash.), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc. of Palo Alta, Calif.; the Xen hypervisor, an open source product whose development is overseen by Citrix Systems, Inc. of Fort Lauderdale, Fla.; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third-parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 109 may include both the private and public networks 104 and servers 106.

The cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS providers may offer storage, networking, servers, or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g. Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. Google Chrome, Microsoft Internet Explorer, or Mozilla Firefox provided by Mozilla Foundation of Mountain View, Calif.). Clients 102 may also access SaaS resources through smartphone or tablet applications, including e.g., Salesforce Sales Cloud, or Google Drive App. Clients 102 may also access SaaS resources through the client operating system, including e.g. Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g., a mouse. The storage device 128 may include, without limitation, an operating system 129, software 131, and a software of security awareness system 120. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the processor 121 may use an Advanced Graphic Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g. a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116 and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include applications developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.1 la/b/g/n/ac CDMA, GSM, WiMAX and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOWS 10, all of which are manufactured by Microsoft Corporation of Redmond, Wash.; MAC OS and iOS, manufactured by Apple, Inc.; Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, PERSONAL PLAYSTATION PORTABLE (PSP), or a PLAYSTATION VITA device manufactured by the Sony Corporation of Tokyo, Japan; a NINTENDO DS, NINTENDO 3DS, NINTENDO WII, or a NINTENDO WII U device manufactured by Nintendo Co., Ltd., of Kyoto, Japan; or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU, and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Analysis of User Behavior to Improve Security Awareness

The following describes systems and methods for analysis of user behavior to improve security awareness. The methods and systems for detection and analysis of user behavior may assist an organization in making sure users receive appropriate security awareness training tailored to their application and website usage. Such tailored trainings may help ensure that the users adhere to policy without restricting the users from resources or device functions they may need. Through analysis of the user behavior data, categories assigned to the user behavior, and the user data, cybersecurity training that is directly relevant to the user's needs may be targeted. For example, a user that is making regular use of video conferencing applications may be trained with specific guidance on how to keep information secure when using such applications.

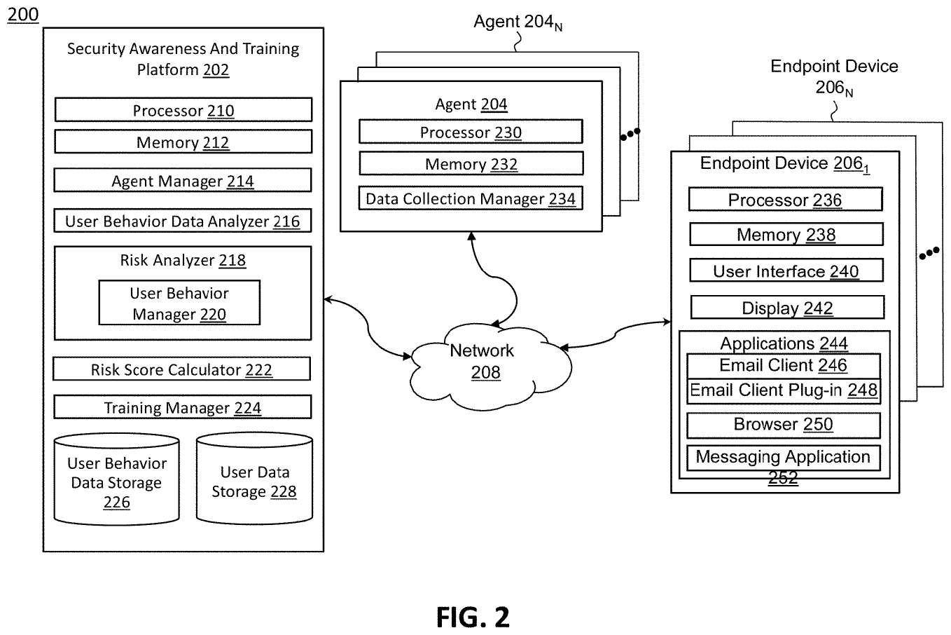

FIG. 2 depicts some of the server architecture of an implementation of system 200 for analysis of user behavior to improve security awareness, according to some embodiments. System 200 may be a part of security awareness system 120. Security awareness system 120 may be a cybersecurity awareness system that manages items relating to cybersecurity awareness for an organization. The organization may be an entity that is subscribed to or makes use of services provided by security awareness system 120. The organization may encompass all users within the organization, vendors to the organization, or partners of the organization. System 200 may include security awareness and training platform 202, agent 204, endpoint device 206_{1-N}, and network 208 enabling communication between the system components for information exchange. Network 208 may be an example or instance of network 104, details of which are provided with reference to FIG. 1A and its accompanying description.

According to one or more embodiments, each of security awareness and training platform 202, agent 204, and endpoint device 206_{1-N} may be implemented in a variety of computing systems, such as a mainframe computer, a server, a network server, a laptop computer, a desktop computer, a notebook, a workstation, and any other computing system. In an implementation, each of security awareness and training platform 202, agent 204, and endpoint device 206_{1-N} may be implemented in a server, such as server 106 shown in FIG. 1A. In some implementations, security awareness and training platform 202, agent 204, and endpoint device 206_{1-N} may be implemented by a device, such as computing device 100 shown in FIGS. 1C and 1D. In some embodiments, each of security awareness and training platform 202, agent 204, and endpoint device 206_{1-N} may be implemented as a part of a cluster of servers. In some embodiments, each of security awareness and training platform 202, agent 204, and endpoint device 206_{1-N} may be implemented across a plurality of servers, thereby, tasks performed by each of security awareness and training platform 202, agent 204, and endpoint device 206_{1-N} may be performed by the plurality of servers. These tasks may be allocated among the cluster of servers by an application, a service, a daemon, a routine, or other executable logic for task allocation. Each of security awareness and training platform 202, agent 204, and endpoint device 206_{1-N} may comprise a program, service, task, script, library, application or any type and form of executable instructions or code executable on one or more processors. Each of security awareness and training platform 202, agent 204, and endpoint device 206_{1-N} may be combined into one or more modules, applications, programs, services, tasks, scripts, libraries, applications, or executable code.

In one or more embodiments, security awareness and training platform 202 may facilitate cybersecurity awareness training, for example, via targeted job profile based trainings, simulated phishing campaigns, computer-based trainings, remedial trainings, and risk score generation and tracking. In some example implementations, security awareness and training platform 202 may be a Computer Based Security Awareness Training (CBSAT) system that performs security services such as performing training campaigns on a user or a set of users of an organization as a part of security awareness training. The user may be an employee of an organization, a client, a vendor, a customer, a contractor, or any person associated with the organization. In some examples, the user may be an individual that is tested and trained by security awareness and training platform 202. The user may include an individual that can or does exhibit user behaviors, an employee of an organization, a member of a group, or an individual who acts in any capacity in security awareness system 120, such as a system administrator. The system administrator may be an individual or team who oversees a security awareness system of the organization with responsibilities including configurations of system personal information use, managing simulated phishing campaigns and simulated attacks, and managing any other element within security awareness system 120.

According to some embodiments, security awareness and training platform 202 may include processor 210 and memory 212. For example, processor 210 and memory 212 of security awareness and training platform 202 may be CPU 121 and main memory 122, respectively, as shown in FIGS. 1C and 1D. According to an embodiment, security awareness and training platform 202 may include agent manager 214, user behavior data analyzer 216, risk analyzer 218, risk score calculator 222, training manager 224, user behavior data storage 226, and user data storage 228. Agent manager 214 may generate and deploy one or more agent(s) 204_{1-N} for one or more corresponding endpoints devices 206_{1-N} for monitoring a user behavior. For the sake of simplifying the explanation, one or more agent(s) 204_{1-N} and one or more endpoint devices 206_{1-N} may be referred to as agent 204 and endpoint device 206, respectively. In one embodiment, agent manager 214 may install and/or deploy agent 204 within endpoint device 206. In some embodiments, agent manager 214 may deploy agent 204 external to endpoint device 206, such as in an external server, and provide access to endpoint devices 206. In some embodiments, agent manager 214 may deploy agent 204 within and outside endpoint device 206, for example using cloud-based technology. Agent manager 214 may monitor user's behavior at endpoint device 206 associated with the user. User's behavior may be monitored based on the user's interaction with websites and/or various applications. In one embodiment, agent manager 214 may detect user behavior through agent 204 associated with endpoint devices 206. Agent manager 214 may obtain user's behavior data from endpoint device 206 through agent 204. The user behavior data may be data collected on the user's behavior by agent 204 running on endpoint device 206. For example, the behavior data can include data involving websites the user visits or applications the user has on their endpoint. Some examples of the user behavior data may include, but are not limited to, websites the user has visited and any associated metadata, applications on endpoint device 206 and any associated metadata, applications initiated or running on endpoint device 206 and any associated metadata, configuration of a browser 250 at endpoint device 206 and any associated metadata, credentials stored in the browser and any associated metadata of any file downloaded from browser 250 onto endpoint device 206.

User behavior data analyzer 216 may be a program or a function configured to analyze the user behavior data, and assign websites and applications to categories based on analysis of the user behavior data. In one or more embodiments, user behavior data analyzer 216 may include Artificial Intelligence (AI) or Machine Learning (ML) modules to analyze the user behavior data. In one or more embodiments, user behavior data analyzer 216 may use the user behavior data to categorize websites visited, and/or applications used by the user into one or more categories. The one or more categories are categorizations of websites and/or applications that are based on characteristics of the web sites and/or applications. The categories may be in the form or groups or tags on the web sites and/or applications. The categorizations may include groups that the applications or websites are added into. In one embodiment, the categorizations may include core function categories and attribute categories. Each of the websites and/or applications may have a core function. User behavior data analyzer 216 may identify a core function of a given website or an application, and based on the identified core function, user behavior data analyzer 216 may assign an appropriate core function category to the website or the application. In one example, user behavior data analyzer 216 may identify the core function by analyzing descriptions or details associated with the website or the application. Some examples of core functions may include, but are not limited to, word processors, videoconferencing, financial accounting, sales planning, instant messaging/collaboration, file and document storage, time tracking, payment processing, photo/video editing for the web sites or applications. In one example, user behavior data analyzer 216 may assign a core function category to an application such as QuickBooks as a “financial accounting” core function category. In another example, user behavior data analyzer 216 may assign a core function category to an application such as Adobe Photoshop as a “photo editing” core function category.

The attribute category may be associated with an attribute of the website and/or application or the user behavior regarding the website and/or application. User behavior data analyzer 216 may identify an attribute of a website or an application, and based on the corresponding attribute, user behavior data analyzer 216 may assign an appropriate attribute or core function category to the website or the application. Non-limiting examples of attributes include, but are not limited to, whether there are fields to input credentials on the website, whether the web site or application uses camera or microphone access, whether the website was visited securely or not, whether the website is associated with stored credentials in the browser, a length of time that credentials have been stored in a browser, a file type downloaded from the browser, or a frequency of use of the website or the application by the user. In one embodiment, user behavior data analyzer 216 may inspect a markup language of the visited websites to detect attribute categories. In one example, user behavior data analyzer 216 may analyze the markup language of a website to determine whether a website includes fields to input credentials. In situations where the categorizations of a web site or application are not included in a database or are not immediately available, user behavior data analyzer 216 may infer the categories of a web site or application. In another example, user behavior data analyzer 216 may analyze the markup language of a website to determine whether the website seeks access to a camera or microphone of endpoint device 206. User behavior data analyzer 216 may parse the markup language for strings that are commonly used to prompt users for access to a camera or microphone of endpoint device 206. A non-limiting example string that prompts users for access to a camera is provided below.

```
var video = document.getElementById(‘video’);
if(navigator.mediaDevices && navigator.mediaDevices.getUserMedia) {
  navigator.mediaDevices.getUserMedia({ video: true
  }).then(function(stream) {
    video.src = window.URL.createObjectURL(stream);
    video.play( );
});
```

User behavior data analyzer 216 may parse and analyze Uniform Resource Locators (URLs) of web sites stored in user behavior data storage 226 to determine whether the websites were accessed securely. In an example, user behavior data analyzer 216 may search for an “https” at the beginning of the URL to determine whether a website was accessed securely. User behavior data analyzer 216 may analyze credentials stored in browser 250 of endpoint device 206, and may determine a length of time that the credentials have been stored in the browser. To determine the length of time, user behavior data analyzer 216 may maintain a log of the credentials stored over time in user behavior data storage 226, and may analyze the log occasionally or periodically to determine similarities or changes in the stored credentials. User behavior data analyzer 216 may store the credentials as hashed or encrypted credentials. User behavior data analyzer 216 may analyze download history and/or downloaded files to determine a file type downloaded from the browser. User behavior data analyzer 216 may analyze timestamps related to a browser history and determine how long users were using a web site and how frequently a given web site was visited. Based on the length of time of using the website and frequency of visiting the given website, user behavior data analyzer 216 may assign corresponding attribute categories to those websites. For example, a web site may appear in the browser history twelve times in one day. User behavior data analyzer 216 may determine that twelve visits per day is an indicator of a website that is frequently used and may assign the web site the attribute category of “high frequency of use”. In some examples, user behavior data analyzer 216 may set thresholds to define low frequency of use, medium frequency of use and high frequency of use. In an example, two visits or less to a website per day may be set as a threshold to define low frequency of use. In an example, five visits or less to a website per day may be set as a threshold to define medium frequency of use, and above five visits may be set as a threshold to define high frequency of use.

In some examples, user behavior data analyzer 216 may determine the core function category from attribute categories of the websites and applications that are gathered from the user behavior data. For example, an application that is assigned an attribute category of “requires camera and microphone access” may be assigned to the core function category of “videoconferencing”. In another example, an application that is assigned an attribute category of “requires photo gallery and camera access” may be assigned to the core function category of “photo editor”. In some examples, the organization or system administrator may have information about the user, including the user's job role stored in a user data storage within security awareness and training platform 202. In some examples, an organization, system administrator, third-party or database may manually create categories and assign categories to web sites or applications.

Risk analyzer 218 may be a program configured to determine the risk that a user behavior poses to a security of an organization. In some examples, risk analyzer 218 may use Artificial Intelligence (AI) and/or Machine Learning (ML) to determine risk. In one example, risk analyzer 218 may determine the risk by analyzing, at least in part, current user behavior data, past user behavior data, the categories assigned to web sites and applications (e.g., the core function and attribute categorizations) used by the user, and the user data. In an example, risk analyzer 218 may consider a visit to a videoconferencing core function website with an attribute of not being visited securely as risky or high risk. Risk analyzer 218 may also analyze the user behavior data to detect risk. For example, risk analyzer 218 may analyze a string of a web site URL to determine if the URL is similar to a spelling of another well-known website URL, which would result in the determination that the website was a higher risk. For example, risk analyzer 218 may analyze a user's visit to a URL (www.bankofamerca.com (note the missing ‘i’)) that appears similar to URL of a Bank of America (www.bankofamerica.com) as a high risk. In some examples, risk analyzer 218 may determine the amount of risk based on the job role of the user in combination with the category of the applications or websites. For example, if the user's job role is “research and development”, then risk analyzer 218 may determine that an application with videoconferencing as its core function category is high risk because the possibility of accidentally revealing sensitive information in the background of a videoconference call is very high. In an example, if a user's job role is “software developer”, then risk analyzer 218 may determine that accessing a patent search website by the user is a high risk due to the possibility of accidentally or deliberately copying inventions from patents. However, in an example, if a person in the legal department of the same organization of the above software developer accesses the patent search website, then risk analyzer 218 may determine the behavior to be a low risk because of a job role in the legal department may require such access to the patent search website. In some examples, risk analyzer 218 may determine whether the user behavior is aligned with organizational policy.

Risk analyzer 218 may include user behavior manager 220. User behavior manager 220 may be configured to detect the risk that user behaviors pose to the organization based on whether the user behavior data indicates that the user is behaving abnormally for their job role or behaving abnormally compared to their past behavior. User behavior manager 220 may include an AI and/or ML models trained with previous user behavior data of the user or other users with the same or similar job roles to determine whether the user is behaving abnormally for their job role or behaving abnormally compared to their past behavior. For example, one or more users with the job role ‘executive assistant’ may have their user behavior data collected by data collection manager 234, and their user behavior data analyzed and assigned to categories by user behavior data analyzer 216. User behavior manager 220 may aggregate and analyze the one or more user data, past user behavior data, and the categories assigned to their user behavior data to determine when one of those users is exhibiting behavior that is not within the normal functioning of their job role. User behavior manager 220 may also detect when a user deviates from their regular behavior and/or may notify the user or a system administrator that the user is deviating from their usual behavior. For example, user behavior manager 220 may detect the user has used a Zoom™ (Zoom Video Communications, San Jose, Calif.) application for calls, which is a deviation from usual Skype™ (Microsoft, Mountain View, Calif.) calls. Risk analyzer 218 may provide risk analysis results determined through the analysis to risk score calculator 222.

Using the risk analysis results, risk score calculator 222 may determine a risk score for a user. Risk score calculator 222 may be a program or an application configured to calculate, store, and maintain risk scores. The risk score may be a metric that reflects a cybersecurity risk that a user poses to an organization. The risk score may reflect the cybersecurity risk of a user, a group of users, an organization, an industry, a geography, or any other subset of users. The risk score may be influenced by the user's behavior, training received, their job role within an organization, or any other attribute that may be associated with the user. Risk score calculator 222 may use the risk analysis results in determining risk scores. For example, risk score calculator 222 may determine a risk score based on a count of the number of user behaviors determined to be risky from the risk analysis results. In an example, risk score calculator 222 may calculate a risk score based on a weighted average of the severity of the user behaviors determined from the risk analysis results. In some examples, the risk score may be a function of any of the elements in the risk analysis, and the function may be a weighted function or logarithmic function. In one or more embodiments, risk score calculator 222 may be configured to calculate a group risk score based on a function of the risk score of each user within the group of users. For example, a risk analysis may be performed for users in a software development group and risk score calculator 222 may determine a group risk score for the software development group based on the risk analysis results of the users in the software development group. The group risk score may indicate the risk posed by the software development group's behavior to the organization.

Training manager 224 may be a program or a function configured to deliver training to a user based on the categories assigned to the user behavior, the results of the risk analysis, the user data, and/or a combination thereof. For example, training manager 224 may administer a training to provide a user knowledge on how to access and use an application in the most secure manner when the user behavior is found to be high risk through risk analysis by risk analyzer 218. In another example, training manager 224 may administer training to provide the user knowledge on how to change their credentials if the results of a risk analysis for the user indicates that the behavior was high risk, and that the user's credentials were involved. In some examples, training manager 224 may administer a training focused on reinforcing pertinent organizational policy to the user when a result of the user behavior analysis determines the user behavior to be in violation of the organization's policy. In some examples, training manager 224 may administer a training focused on reinforcing pertinent organizational policy to the user when a result of the user behavior analysis determines the user behavior to be in violation of the organization's policy because of the job role of the user that displayed the behavior. In an example, training manager 224 may administer a training to the user after detection and analysis of improper user behavior. For example, for a user who visits many websites in a manner that is determined to be ‘high risk’ by risk analyzer 218, training manager 224 may be deliver training on reducing the risks specific to the websites with the same core function category. In some examples, for a user who exhibits a user behavior that indicates deviation from the behavior of others with the same job role, training manager 224 may notify the user that the user behavior deviates from the behavior of others with the same job role, and may provide training to the user on how to use the application or website safely. Considering the above example where user behavior manager 220 may detect the user is using Zoom™ (Zoom Video Communications, San Jose, Calif.) application for calls, which is a deviation from usual Skype™ (Microsoft, Mountain View, Calif.) calls, training manager 224 may notify the user that the user behavior deviates from the behavior of others with the same job role, and may provide training to the user on how to use the Zoom™ (Zoom Video Communications, San Jose, Calif.) application safely. In an example, the system administrator may also receive the notification that a user's behavior is deviating from the behavior of others with the same job role. Training manager 224 may use AI or ML to adjust future training for the user based on changes in the user behavior. For example, the user may have the same job role but take on more responsibilities at work causing a change in user behavior. User behavior manager 220 may detect the change in user behaviors that may correlate with more responsibilities and may communicate with training manager 224 on the changes and correlation with different responsibilities. In response, training manager 224 may train the user on how to use the new websites and applications the user is regularly utilizing safely.

User behavior data storage 226 may store user behavior data which is collected from endpoint device 206 by agent 204. User data storage 228 may store user related information such as profile, role, position, joining date, and any other user information.

Referring to FIG. 2, agent 204 may be a program or a function configured to assist security awareness and training platform 202 in monitoring the user's behaviors on the endpoint device 206 including behaviors associated with browser 250, applications 244, messaging application 252, software installed on endpoint device 206, and any other behavior. According to some embodiments, agent 204 may include processor 210 and memory 212. For example, processor 230 and memory 232 of agent 204 may be CPU 121 and main memory 122, respectively, as shown in FIGS. 1C and 1D. Agent 204 may include data collection manager 234. Data collection manager 234 may be a program or a function that may work with agent 204 to collect user behavior data from endpoint device 206. In some examples, data collection manager 234 may collect user behavior data when prompted by agent 204 associated with endpoint device 206. Agent 204 may extract data from internet browser 250 installed on endpoint devices 206 in coordination with data collection manager 234. Agent 204 may monitor the user behavior running on endpoint device 206 and prompt data collection manager 234 to collect user behavior data when appropriate. Data collection manager 234 may act in coordination with agent 204 to access any portion of internet browser 250, browser history or visited websites to extract user behavior data. Data collection manager 234 may, for example, extract browser history and associated metadata about the browser history, including the names of websites visited and markup language of the webpages.

In some examples, data collection manager 234 may use a script to locate user behavior data from browser 250. In some examples, data collection manager 234 may access a markup language of a website and may download the website and usage information to user behavior data storage 226. A non-limiting example of a script that data collection manager 234 may use to locate and extract the markup language of a given website, example.com, is provided below.

>>> import requests
url = ‘http:// example.com’
>>> r = requests.get(url)
>>> txt = r.text
>>> print(txt)

Data collection manager 234 may also access a download history of browser 250 and/or download the download history to user behavior data storage 226. Data collection manager 234 may extract and download data associated with a browser configuration to enable determining whether there are add-ons and/or plugins installed on browser 250, and to enable determining identities of the add-ons and/or plugins. A non-limiting example of a script that data collection manager 234 may use to investigate the presence of plugins or add-ons in internet browser 250 is provided below.

```
askBrowser (numPlugins)
if (numPlugins > 0)
  document.write(plugin.name);
else
  return 0;
```

Data collection manager 234 may access and download stored credentials of the user in browser 250. Data collection manager 234 may obtain the length of time that the credentials have been stored in browser 250. Data collection manager 234 may collect timestamps related to the browser history and determine how long users were using a website and how frequently the website was visited. Data collection manager 234 may store downloaded website, usage information, a download history, downloaded data, add-ons and/or plugins information, stored credentials of the user in browser 250, length of time that the credentials have been stored in browser 250, timestamps related to the browser history and any other collected information to user behavior data storage 226.

Below is a non-limiting example of a code that data collection manager 234, in coordination with the agent, may use to investigate whether the currently viewed web site has permission to view the camera on the endpoint.

```
const getCameraPermission = async ( ) => {
  let state = ‘unknown’
  try {
  const permission = await navigator.permissions.query({ name: ‘camera’
  })
      state = permission.state
    } catch {
      const resp = await navigator.mediaDevices.enumerateDevices( )
      const camera = resp.find(device => device.kind === ‘videoinput’)
      state = camera?.label ? ‘granted’ : ‘prompt or rejected’
    }
    console.log(‘Camera State:’, state, ‘URL:’, window.location.href)
    return { cameraState: state, url: window.location.href }
}
```

Data collection manager 234 may work with endpoint device 206 to gather data from endpoint device 206 and browser 250. Data collection manager 234 in coordination with agent 204 may extract data from endpoint device 206 about applications in endpoint device 206. For example, data collection manager may run a script that may search the device registry for the presence of applications installed on the endpoint. Data collection manager 234, in collaboration with agent 204, may also search the registry of the endpoint device for timestamps of application usage. A non-limiting example of the script that data collection manager 234, in coordination with agent 204, may use to query a registry of endpoint device 206 to investigate the presence of applications installed on endpoint device 206 is provided below.
$InstalledSoftware=Get-ChildItem
“HKLM: \Software\Microsoft\Windows\CurrentVersion\Uninstall”
foreach($obj in $InstalledSoftware){write-host
$obj.GetValue(‘DisplayName’)-NoNewline; write-host”

Data collection manager 234 may be configurable to limit or filter the locations on endpoint device 206 where data is collected in order to optimize processing time and power. For example, data collection manager 234 may be configured to only collect data from certain folders on the disk or certain places in the registry of endpoint device 206. Data collection manager 234 may communicate the user behavior data to user behavior data storage 226.

Referring to FIG. 2, in some embodiments, endpoint device 206 may be any device used by the user to perform a job function. Endpoint device 206 may be any computing device, such as a desktop computer, a laptop, a tablet computer, a mobile device, a Personal Digital Assistant (PDA), smart glasses, or any other computing device. In an implementation, endpoint device 206 may be a device, such as client device 102 shown in FIG. 1A and FIG. 1B. Endpoint device 206 may be implemented by a device, such as computing device 100 shown in FIG. 1C and FIG. 1D. According to some embodiments, endpoint device 206 may include processor 236 and memory 238. In an example, processor 236 and memory 238 of endpoint device 206 may be CPU 121 and main memory 122, respectively, as shown in FIGS. 1C and 1D. Endpoint device 206 may also include user interface 240, such as a keyboard, a mouse, a touch screen, a haptic sensor, a voice-based input unit, or any other appropriate user interface. It shall be appreciated that such components of endpoint device 206 may correspond to similar components of computing device 100 in FIGS. 1C and 1D, such as keyboard 126, pointing device 127, I/O devices 130a-n and display devices 124a-n. Endpoint device 206 may also include display 242, such as a screen, a monitor connected to the device in any manner, a wearable glass, or any other appropriate display. In an implementation, endpoint device 206 may display received content (for example, messages) for the user using display 242 and is able to accept user interaction via user interface 240 responsive to the displayed content.

In some implementations, endpoint device 206 may include a communications module (not shown). This may be a library, an application programming interface (API), a set of scripts, or any other code that may facilitate communications between endpoint device 206 and any of security awareness and training platform 202, agent 204, and a third-party server or any other server. In some embodiments, the communications module may determine when to transmit information from endpoint device 206 to external servers via network 210. In some embodiments, the communications module receives information from security awareness and training platform 202, agent 204 and third-party servers via network 104. In some embodiments, the information transmitted or received by the communications module may correspond to a message, such as an email, generated or received by messaging application 252.

In an implementation, endpoint device 206 may include messaging application 252. Messaging application 252 may be any application capable of viewing, editing, and/or sending messages. For example, messaging application 252 may be an instance of an application that allows viewing of a desired message type, such as any web browser, a Gmail™ application (Google, Mountain View, Calif.), Microsoft Outlook™ (Microsoft, Mountain View, Calif.), WhatsApp™ (Facebook, Menlo Park, Calif.), a text messaging application, or any other appropriate application. In some embodiments, messaging application 252 can be configured to display electronic training. In some examples, endpoint device 206 may receive notifications from training manager 224 via messaging application 252, display received messages for the user using display 242, and display training provided by training manager 224.

Referring again to FIG. 2, in some embodiments, endpoint device 206 may contain one or more applications 244 including email client 246, browser 250, messaging application 252 and any other applications. The term “application” as used herein may refer to one or more applications, services, routines, or other executable logic or instructions. In one example implementation, email client 246 may be an application installed on endpoint device 206. In another example implementation, email client 246 may be an application that can be accessed over network 208 without being installed on endpoint device 206. In an implementation, email client 246 may be any application capable of composing, sending, receiving, and reading email messages. For example, email client 246 may be an instance of an application, such as Microsoft Outlook™ application, IBM® Lotus Notes® application, Apple® Mail application, Gmail® application, or any other known or custom email application. In an example, a user of endpoint device 206 may be mandated to download and install email client 246 by the organization. In another example, email client 246 may be provided by the organization by default. In some examples, a user of endpoint device 206 may select, purchase and/or download email client 246 through an application distribution platform.

In one or more embodiments, email client 246 may include email client plug-in 248. An email client plug-in may be an application or program that may be added to an email client for providing one or more additional features or for enabling customization to existing features. For example, email client plug-in 248 may be used by the user to report suspicious emails. In an example, email client plug-in 248 may include a user interface (UI) element such as a button to trigger an underlying function. The underlying function of client-side plug-ins that use a UI button may be triggered when a user clicks the button. Some examples of client-side plug-ins that use a UI button include, but are not limited to, a Phish Alert Button (PAB) plug-in, a Report Message add-in, a task create plug-in, a spam marking plug-in, an instant message plug-in, a social media reporting plug-in and a search and highlight plug-in. In an embodiment, email client plug-in 248 may be a PAB plug-in.

In an exemplary operation, the user may be using endpoint device 206 to perform job functions. In one example, the user may be a software developer. As a part of their job function or otherwise, the user may use applications 244, such as email client 246 and browser 250. The user may use applications 244 for job functions or for personal purposes. For example, the user may access a browser to browse for solution to a problem that the user is facing in developing code. In another example, the user may use a video conferencing application to talk to a vendor or use a patent search tool to search for a solution that may solve the problem the user is facing. The usage of video conferencing applications and/or usage of the patent search tool may pose a risk for the organization. In an embodiment, agent manager 214 may deploy an agent 204 to monitor user behavior in endpoint device 206. Data collection manager 234 in collaboration with agent 204 may collect user behavior data from endpoint device 206. In an example, data collection manager 234 may access applications 244, messaging application 252 and browser 250 from endpoint device 206, and collect user behavior data including usage of applications 244, browsing data, etc. Data collection manager 234 may store the collected user behavior data in user behavior data storage 226. User behavior data analyzer 216 may analyze the user behavior data, and use the analysis to categorize applications 244 used into one or more categories. In the above example, user behavior data analyzer 216 may categorize the video conferencing application based on core function “video conferencing”, and the patent search tool based on core function “data research”. In another example, user behavior data analyzer 216 may also categorize the video conferencing application to “video conferencing” based on attribute “application uses camera or microphone access”, and the patent search tool as “data research”, based on attribute “whether there are fields to input credentials on the website.” Risk analyzer 218 may determine the risk that a user behavior poses to the security of the organization based on the categories of the applications and web sites, the user behavior data, and the user data. Risk analyzer 218 may also determine where the user behavior is aligned or not aligned with organizational policy. User behavior manager 220 of risk analyzer 218 may determine that the user is behaving abnormally or deviating from their regular behavior. Risk analyzer 218 may provide risk analysis results based on the determination. Risk score calculator 222 may calculate a risk score based on risk analysis results. In the example, risk score calculator 222 may show a high risk score as the user may not be securely using a video conferencing tool, thereby possibly risking exposure of strategic or proprietary information to a vendor. In an example, a user is violating the organizational policy by not using the patent search tool. Risk score calculator 222 may display the risk score to the user on display 242 on endpoint device 206. In an example, training manager 224 may determine a type of electronic security training to provide to the user based at least on the one or more categories and the risk score of the user. In the current example, training manager 224 may determine a type of training that imparts knowledge of secure usage of video conference applications, and a type of training that reinforces pertinent organizational policy. Training manager 224 may provide the determined types of electronic security trainings to endpoint device 206 of the user.

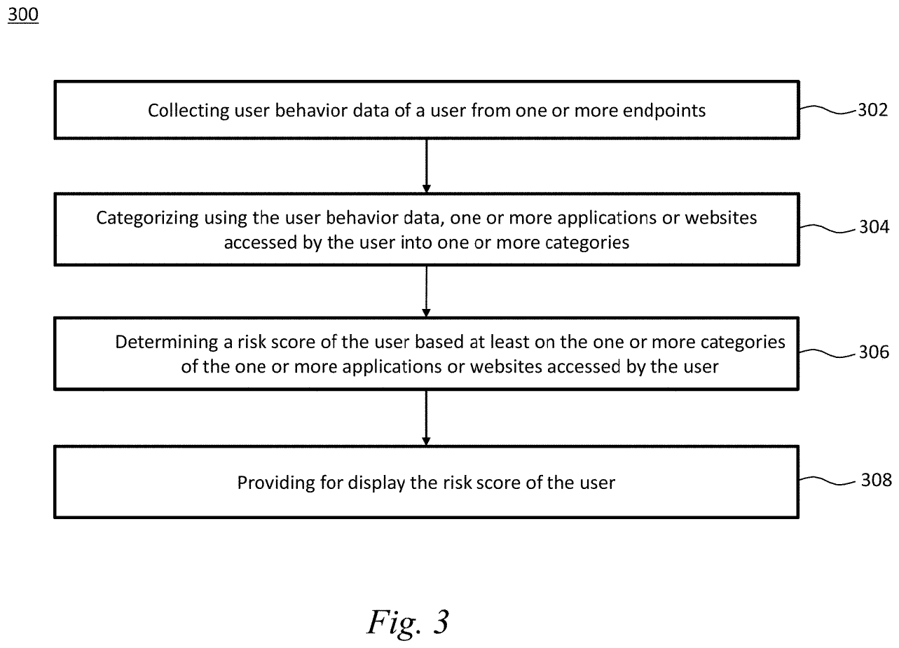

Referring to FIG. 3 in a general overview, FIG. 3 depicts an implementation of a method 300 for determining a risk score of a user based on user behavior data, according to one embodiment. In a brief overview of an implementation of flowchart 300, at step 302, user behavior data of a user may be received from one or more agents on one or more endpoint devices accessed by a user. At step 304, one or more applications or web sites accessed by the user may be categorized into one or more categories, using the user behavior data. At step 306, a risk score of the user may be determined based at least on the one or more categories of the one or more applications or websites accessed by the user. At step 308, the risk score of the user may be provided for display.

Step 302 includes receiving user behavior data of a user from one or more agents 204_{1-N} on one or more endpoint devices 206_{1-N} accessed by a user. In some examples, the user behavior data includes one or more of any websites the user has visited and any associated metadata, applications on the one or more endpoint devices and any associated metadata, applications initiated or running on the one or more endpoint devices and any associated metadata, configuration of a browser on the one or more endpoint devices and any associated metadata, credentials stored in the browser and any associated metadata, and any file downloaded from the browser onto the one or more endpoint devices and any associated metadata.

Step 304 includes categorizing, using the user behavior data, one or more applications or websites accessed by the user into one or more categories. In one or more embodiments, the categorization may be performed by user behavior data analyzer 216. In some examples, categorizing the one or more applications or websites accessed by the user into one or more categories includes the identification of a core function. In some examples, the core function may include one of a word processor, video conferencing, financial accounting, or sales planning. In some examples, categorizing one or more applications or websites accessed by the user into one or more categories includes identification of an attribute. In some examples, the attribute may include one of whether there are fields to input credentials on the web site, whether the website or application uses camera or microphone access, whether the website was visited securely or not, whether the website is associated with stored credentials in the browser, a length of time that credentials have been stored in a browser, a file type downloaded from the browser, or a frequency of use of the website or the application by the user.

Step 306 includes determining a risk score of the user based at least on the one or more categories of the one or more applications or websites accessed by the user. In one or more embodiments, the risk score of the user may be calculated by risk score calculator 222. In some examples, risk score calculator 222 may determine the risk score for the user based on the user behavior data. In some examples, risk score calculator 222 may determine the risk score for the user based on a job role of the user. Step 308 includes providing for display the risk score of the user. In one or more embodiments, risk score calculator 222 may provide the risk score of the user for display. The risk score may be displayed on display 242.

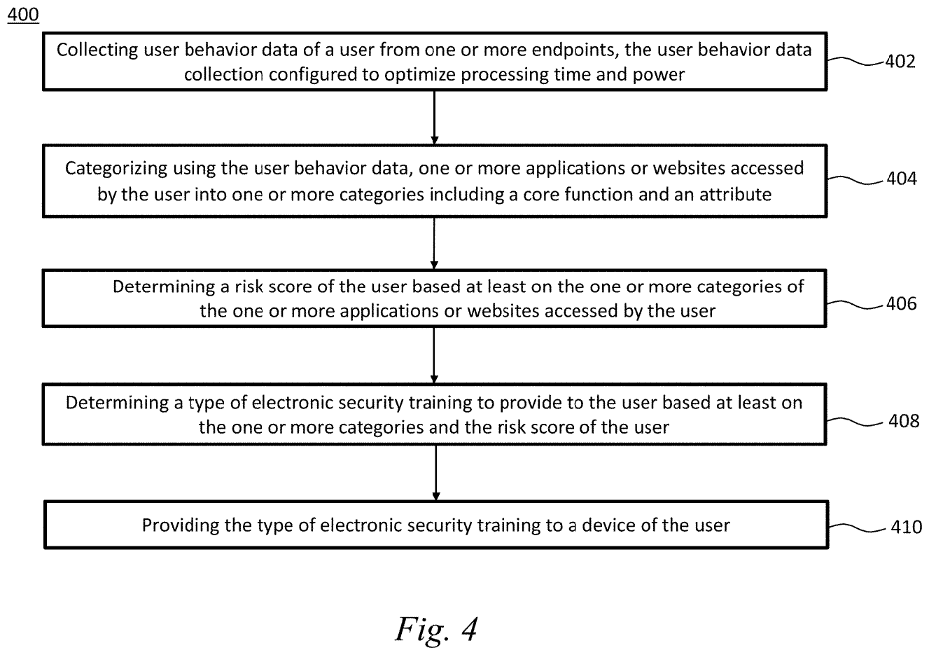

Referring to FIG. 4 in a general overview, FIG. 4 depicts an implementation of a method 400 for providing a type of electronic security training to the user based at least on the risk score of the user, according to one embodiment. In a brief overview of an implementation of flowchart 400, at step 402, user behavior data of a user may be received from one or more agents on one or more endpoint devices accessed by a user. At step 404, one or more applications or websites accessed by the user may be categorized into one or more categories, using the user behavior data. At step 406, a risk score of the user may be determined based at least on the one or more categories of the one or more applications or websites accessed by the user. At step 408, a type of electronic security training may be determined to provide to the user based at least on the one or more categories and the risk score of the user. At step 410, the type of electronic security training may be provided to endpoint device 206 of the user.

Step 402 includes receiving user behavior data of a user from one or more agents 204_{1-N} on one or more endpoint devices 206_{1-N} accessed by a user. In some examples, the user behavior data includes one or more of any of websites the user has visited and any associated metadata, applications on the one or more endpoint devices and any associated metadata, applications initiated or running on the one or more endpoint devices and any associated metadata, configuration of a browser the one or more endpoint devices and any associated metadata, credentials stored in the browser and any associated metadata, and any file downloaded from the browser onto the one or more endpoint devices and any associated metadata.

Step 404 includes categorizing, using the user behavior data, one or more applications or websites accessed by the user into one or more categories. In one or more embodiments, the categorization may be performed by user behavior data analyzer 216. In some examples, categorizing one or more applications or websites accessed by the user into one or more categories includes identification of a core function. In some examples, the core function may include one of a word processor, video conferencing, financial accounting, or sales planning. In some examples, categorizing one or more applications or websites accessed by the user into one or more categories includes identification of an attribute. In some examples, the attribute includes one of whether there are fields to input credentials on the website, whether the website or application uses camera or microphone access, whether the website was visited securely or not, whether the website is associated with stored credentials in the browser, a length of time credentials have been stored in a browser, a file type downloaded from the browser, and a frequency of use of the website or the application by the user.

Step 406 includes determining a risk score of the user based at least on the one or more categories of the one or more applications or websites accessed by the user. In one or more embodiments, the risk score of the user may be calculated by risk score calculator 222. In some examples, risk score calculator 222 may determine the risk score for the user based on the user behavior data. In some examples, risk score calculator 222 may determine the risk score for the user based on a job role of the user. Step 408 includes determining a type of electronic security training to provide to the user based at least on the one or more categories and the risk score of the user. In one or more embodiments, the type of electronic security training to be provided to the user may be determined by training manager 224. Step 410 includes providing the type of electronic security training to endpoint device 406 of the user. In one or more embodiments, training manager 224 may provide the type of electronic security training to the user. Training manager 224 may provide the type of electronic security training on display 242 of endpoint device 206.

The systems described above may provide multiple combinations of any or each of the components and the components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, and/or computer readable non-volatile storage units (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method for delivering security awareness training to one or more users of an organization responsive to determining that the user behavior of the one or more users poses a security risk to the organization, the method comprising:
receiving, by a server, user behavior data of one or more users of an organization from one or more agents on one or more endpoint devices accessed by the one or more users;
determining, by the server using the user behavior data, one or more risk scores representative of the severity of risk associated with the user behavior of the one or more users;
determining, based on the one or more risk scores representative of the severity of risk associated with the user behavior of the one or more users, that the behavior of the one or more users poses a security risk to the organization; and
delivering, in response to the determination that the user behavior of the one or more users of the organization poses a security risk to the organization, electronic security awareness training to the one or more users.

2. The method of claim 1, further comprising:
categorizing, by the server using the user behavior data, one or more applications or websites accessed by the one or more users into one or more categories; and
determining, by the server, the one or more risk scores of the one or more users based at least on the one or more categories of the one or more applications or websites accessed by the one or more users.

3. The method of claim 1, wherein the user behavior data comprises one or more of any of the following: websites the one or more users have visited and any associated metadata, applications on the one or more endpoint devices and any associated metadata, applications initiated or running on the one or more endpoint devices and any associated metadata, configuration of a browser the one or more endpoint devices and any associated metadata, credentials stored in the browser and any associated metadata and any file downloaded from the browser onto the one or more endpoint devices and any associated metadata.

4. The method of claim 1, further comprising categorizing one or more applications or websites accessed by the one or more users into one or more categories comprising identification of a core function.

5. The method of claim 4, wherein the core function comprises one of a word processor, video conferencing, financial accounting, or sales planning.

6. The method of claim 1, further comprising categorizing the one or more applications or websites accessed by the one or more users into one or more categories comprising identification of an attribute.

7. The method of claim 6, wherein the attribute comprises one of the following: whether there are fields to input credentials on the website, whether the website or application uses camera or microphone access, whether the website was visited securely or not, whether the website is associated with stored credentials in the browser, a length of time credentials have been stored in a browser, a file type downloaded from the browser, a frequency of use of the website or the application by the one or more users.

8. The method of claim 1, further comprising determining, by the server, the risk score for the one or more users based at least on a job role of the one or more users.

9. The method of claim 2, further comprising determining, by the server, a type of electronic security training to provide to the one or more users based at least on the one or more categories and the risk score of the one or more users.

10. The method of claim 9, further comprising providing, by the server, the type of electronic security training to the endpoint device of the one or more users.

11. A system for delivering security awareness training to one or more users of an organization responsive to determining that the user behavior of the one or more users engaging poses a security risk to the organization, the system comprising:
one or more servers comprising one or more processors and configured to:
receive, by a server, user behavior data of one or more users of the organization from one or more agents on endpoint devices accessed by the one or more users;
determine, by the server, risk scores representative of the severity of risk associated with the user behavior of the one or more users;
determine, based at least on the risk scores representative of the severity of risk associated with the user behavior of the one or more users, that the behavior of the one or more users poses a security risk to the organization; and
deliver, in response to the determination that the user behavior of the one or more users of the organization poses a security risk to the organization, electronic security awareness training to the one or more users.

12. The system of claim 11, wherein the one or more servers are further configured to:
categorize, using the user behavior data, one or more applications or websites accessed by the one or more users of the organization into one or more categories; and
determine a risk score of the one or more users based at least on the one or more categories of the one or more applications or websites accessed by the one or more users.

13. The system of claim 11, wherein the user behavior data comprises one or more of any of the following: websites the one or more users have visited and any associated metadata, applications on the one or more endpoint devices and any associated metadata, applications initiated or running on the one or more endpoint devices and any associated metadata, configuration of a browser the one or more endpoint devices and any associated metadata, credentials stored in the browser and any associated metadata an any file downloaded from the browser onto the one or more endpoint devices and any associated metadata.

14. The system of claim 11, wherein the one or more servers are further configured to categorize one or more applications or websites accessed by the one or more users into one or more categories comprising identification of a core function.

15. The system of claim 14, wherein the core function comprises one of a word processor, video conferencing, financial accounting, or sales planning.

16. The system of claim 11, wherein the one or more servers are further configured to categorize the one or more applications or websites accessed by the one or more users into one or more categories comprising identification of an attribute.

17. The system of claim 16, wherein the attribute comprises one of the following: whether there are fields to input credentials on the website, whether the website or application uses camera or microphone access, whether the website was visited securely or not, whether the website is associated with stored credentials in the browser, a length of time credentials have been stored in a browser, a file type downloaded from the browser, a frequency of use of the website or the application by the one or more users.

18. The system of claim 11, wherein the one or more servers are further configured to determine the risk score for the one or more users based at least on a job role of the one or more users.

19. The system of claim 11, wherein the one or more servers are further configured to determine a type of electronic security training to provide to the one or more users based at least on the one or more categories and the risk score of the one or more users.

20. The system of claim 19, wherein the one or more servers are further configured to provide the type of electronic security training to the endpoint device of the one or more users.
